(19) United States
(12) Patent Application Publication
(10) Pub. No.: US 2024/0341321 A1
(43) Pub. Date: Oct. 17, 2024

(54) HEALTHY, SHELF-STABLE NUT SPREADS

(71) Applicants: Nick Yousif, Brockton, MA (US); Marvin J. Rudolph, Sharon, MA (US)

(72) Inventors: Nick Yousif, Brockton, MA (US); Marvin J. Rudolph, Sharon, MA (US)

(21) Appl. No.: 18/630,452

(22) Filed: Apr. 9, 2024

Related U.S. Application Data
(63) Continuation of application No. 17/553,707, filed on Dec. 16, 2021.
(60) Provisional application No. 63/126,783, filed on Dec. 17, 2020.

(51) Int. Cl. A23G 1/56; A23G 1/36; A23G 1/40; A23G 1/46; A23G 1/48

(52) U.S. Cl. CPC A23G 1/56; A23G 1/36; A23G 1/40; A23G 1/46; A23G 1/48; A23V 2002/00

(57) ABSTRACT

This disclosure provides shelf stable cocoa nut spreads with all-natural ingredients. The cocoa nut spreads of this disclosure include less carbohydrates (e.g., sugar), less fats, and more protein, than cocoa nut spreads found in the prior art while maintaining a desirable taste profile. Moreover, the cocoa nut spreads described herein are shelf stable even without the presence of unhealthy or unnatural ingredients. Rather, cocoa nut spread compositions and methods described herein are made shelf stable by achieving reduced water activity with all-natural ingredients and natural yeast and mold inhibitors.

### CROSS-REFERENCE TO RELATED APPLICATIONS

This application is a continuation of U.S. application Ser. No. 17/553,707, filed Dec. 16, 2021, which claims priority to, and the benefit of, U.S. Provisional Application No. 63/126,783, filed Dec. 17, 2020, the contents of each of which are hereby incorporated by reference herein in their entireties.

### TECHNICAL FIELD

This disclosure relates to edible products, most notably healthy, shelf-stable nut spread compositions and methods of making the same.

### BACKGROUND

Cocoa-nut spreads are appreciated by consumers for their convenience and taste. Many cocoa nut spreads, for example, may be stored on a shelf at room temperature for extended periods of time (e.g., up to a year) and do not require any cooking to be consumed. As such, cocoa nut spreads may be especially appealing to consumers with busy school or work schedules and whom may not have much time to spend preparing their food.

Unfortunately, the nutritional value of shelf stable nut spreads is questionable at best. Most spreads rely on unnatural ingredients for their stability and taste. And recently, health professionals have expressed grave concerns about the presence many of those unnatural ingredients, linking them with severe health issues, such as, obesity, diabetes, and even cancer.

### SUMMARY

This disclosure provides healthy, shelf stable cocoa nut spreads with all-natural ingredients. The spreads of this disclosure include less carbohydrates (e.g., sugar), less fats, and more protein, than cocoa nut spreads found in the prior art while maintaining a desirable taste profile. Moreover, the cocoa nut spreads described herein are shelf stable even without the presence of unhealthy or unnatural ingredients. Specifically, cocoa nut spread compositions and methods described herein are made shelf stable by achieving reduced water activity with all-natural ingredients and natural yeast and mold inhibitors. The long shelf life makes these spreads appealing to consumers and convenient to manufactures and food distributors alike.

In an aspect, this disclosure provides a low-water activity nut spread composition. The composition includes nuts, cocoa, and an edible natural yeast and mold inhibitor. Advantageously, compositions of this disclosure include all-natural ingredients that provide a long shelf life, e.g., months to years, and do not require heat treatment, high quantities of carbohydrates (e.g., sugar), or acidulants. As such, nut spread compositions of this disclosure are chocolate compatible and enjoy all the benefits of a shelf stable product without resorting to the inclusion of unhealthy additives. Thus, nut spread compositions provided herein can provide a healthier alternative to nut spreads found in the prior art.

Preferably, the edible natural yeast and mold inhibitor includes a combination of flaxseed and oregano extracts. As such, the natural yeast and mold inhibitor used in compositions of the present disclosure can provide several important benefits, such as, having a minimal to zero impact on flavor, having a clean label, being a non-GMO, being gluten-free and dairy-free, effective at neutral pH, and capable of being provided as a water-soluble liquid or powder to facilitate methods of making the compositions.

Advantageously, compositions of the disclosure may not require any heat processing, such as, pasteurization, cooking, baking, etc., for achieving a stable shelf life, like many common nut spreads. As such, compositions of the disclosure are cheaper, faster, and easier to manufacture. Moreover, while many commonly available nut spreads use acid additives to promote shelf life, compositions of this disclosure may have a neutral pH, thereby improving their compatibility with chocolate. Nut spread compositions of the present disclosure may include an agent that reduces water activity. The agent being an all-natural agent. The agent may be, for example, vegetable glycerin.

Compositions of the disclosure provide healthier, shelf stable alternatives to commonly used cocoa nut spreads. Preferably, the compositions include ingredients derived from nature. For example, while compositions may include a sweetener, the sweetener is preferably derived from a natural source, e.g., agave. In particular, the sweetener may comprise organic agave inulin powder. Moreover, instead of palm oil, which is associated with highly saturated fats, the nut spread composition of the disclosure may use at least one of vegetable oil or hazelnut oil. The nut spread composition may further include plant-derived milk, which is associated with many health benefits. The plant-derived milk may be almond milk. The nuts included in the composition may be hazelnuts.

In another aspect, this disclosure provides a method for preparing a nut spread composition. The method comprising combining nuts, cocoa, and an edible natural mold inhibitor. The natural mold inhibitor may include a combination of flaxseed and oregano extracts. As such, methods of the disclosure can be used to make compositions that are both chocolate compatible and shelf stable without unhealthy ingredients. Preferably, the natural mold inhibitor comprises approximately 0.5 percent of total composition.

Methods of the disclosure provide tasty, shelf stable, spreads without expensive and time-consuming heat processing steps or acidic additives. Accordingly, in some respects, methods of the invention are devoid of a cooking step. Furthermore, compositions made by methods of the disclosure can have a neutral pH, which is compatible with chocolate. To promote shelf stability, methods may include adding a low water activity agent. The low water activity agent may be vegetable glycerin.

Methods of the disclosure provide cocoa nut spreads having less carbohydrates (e.g., sugar), less fats, and more protein, than commercially available cocoa nut spreads and are equally as tasty. To facilitate tastiness, without undermining health qualities, methods may include adding a sweetener derived from agave. The sweetener may comprise less than 8 percent of the total composition. Moreover, preferably, compositions of the disclosure do not palm oil, which is associated with highly saturated fats.

In preferred embodiments, the nuts used by methods of the disclosure include one of peanuts or hazelnuts. The nuts preferably comprise less than 15 percent of total composition. Methods may further include adding whey protein powder. The whey protein powder comprises more than 10 percent of the total composition.

### BRIEF DESCRIPTION OF DRAWINGS

FIG. 1 shows an exemplary nut spread composition on toast.

FIG. 2 shows nutritional facts of an exemplary nut spread composition.

FIG. 3 diagrams a method for making a nut spread composition.

### DETAILED DESCRIPTION

Foods that can be safely stored at room temperature, or “on the shelf,” are called “shelf stable.” To achieve shelf stability, a shelf-stable product has usually been treated by heat, heat and acid or dried to destroy any food borne microorganisms present. If the product cannot be treated by heat or heat and acid, reducing its water activity through drying or formula may be used to achieve shelf stability. Many pathogenic bacteria and/or yeasts and molds cannot grow without water. Water activity is widely recognized for the safety it provides to food because of its control of microbial growth and is considered a critical control point for preventing microbial contamination. The lower the water activity, the less the water in the system behaves like pure water. Pathogenic bacteria are believed to stop growing at water activities less than 0.87 Aw (water activity), while the growth of common spoilage yeasts and molds generally stops at 0.70 Aw.

Most commercially available shelf stable foods have undergone preservation processes in order to be shelf stable, and as such, are often referred to as ‘commercially sterile,’ i.e., will not spoil or cause disease under normal conditions of handling and distribution. However, these foods are generally not completely sterile and may be subject to some type of bacterial spoilage. For example, aciduric and thermoduric bacteria may spoil foods rendered shelf-stable by reduction of the pH to less than 4.6 and application of a pasteurization heat treatment. Certain species of Lactobacillus, Clostridium, and Bacillus are capable of surviving a pasteurization heat process and, under the right conditions, can grow in high-acid foods. It is generally recognized that high-acid foods are more susceptible to spoilage by yeasts and molds but, as indicated above, some bacteria can grow and spoil even heat-processed acid foods.

Reduced water activity may also help to improve shelf stability. The water activity of dry food systems is less than 0.60 and, as a result, all microbial growth stops, and they are not subject to spoilage by microbes as long as the water activity remains equal to or below 0.60. Yeasts and molds are more tolerant to low available water and may spoil these types of foods if the water activity (Aw) is more than 0.60 but less than 0.80. Foods preserved by controlling water activity are more frequently ‘spoiled’ by the action of enzymes than by direct bacterial growth in the foods.

Commonly available nut spreads have sought to provide a shelf stable product by one or more of lowering the pH of the final product below 4.7 by adding acidulent; heating (baking, ultra-high temperature (UHT) processing, aseptic processing) the product; irradiating the product; packaging the product using modified atmosphere packaging (MAP) to suppress yeast and mold growth; and with addition of preservatives, primarily sorbates and benzoates to suppress yeast and mold growth. However, none of these approaches guarantee that the spread with not spoil and often require that unnatural additives are included.

For example, one popular cocoa nut spread that is sold under the trade name NUTELLA relies on a reduction of water activity to achieve shelf stability. However, the reduced water activity formulation that is employed requires the addition of high quantities of added refined sugar, which is a major cause of obesity and other chronic diseases, such as type 2 diabetes. Conversely, compositions of this disclosure achieve a reduced water activity efficient for maintaining long shelf life using all-natural ingredients. For example, in some preferred embodiments, nut spread compositions of the disclosure include vegetable glycerin—a safe, sweet tasting liquid—for its natural water activity depressing properties along with extracts of Origanum vulgare (essential oil of oregano) and flaxseed function as a natural yeast and mold inhibitor.

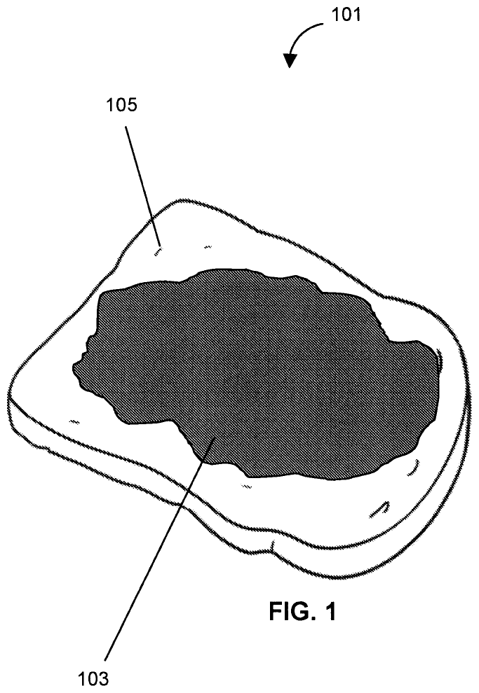

FIG. 1 shows an exemplary nut spread composition 103 on toast 105. The composition 103 is a low-water activity nut spread composition comprising, among other things, nuts, cocoa, and an edible natural mold inhibitor. The nut spread comprises a thickness and spreadability that allows it to be easily spread on bread, toast, crackers, etc.

Water activity (Aw) is practically defined as the partial vapor pressure of water in a headspace that is at equilibrium with the sample divided by the saturated vapor pressure of water at the same temperature. Using this definition, bone-dry samples have a water activity of zero, and pure distilled water has a water activity of exactly one. The lower the water activity, the less the water in the solution behaves like pure water. Higher Aw substances tend to support more microorganisms. A low water activity prevents the growth of microorganisms. Water activity values may be measured with either a resistive electrolytic, a capacitance, or a dew point hygrometer. Pathogenic bacteria are believed to stop growing at water activities less than 0.87 Aw, while the growth of common spoilage yeasts and molds generally stops at 0.70 Aw. Preferably, compositions of the disclosure comprise a water activity level less than 0.87 Aw, for example, less than 0.50 Aw, or less than 0.4 Aw.

The composition 103 includes nuts. Nuts are known to provide a rich source of nutrients, fiber, protein, and healthy fats. A nut in botany is a simple dry fruit in which the ovary wall becomes increasingly hard as it matures, and where the seed remains unattached or free within the ovary wall. Most nuts come from the pistils with inferior ovaries (see flower) and all are indehiscent (not opening at maturity). True nuts are produced, for example, by some plant families of the order Fagales. The nuts may be tree nuts. For example, the nuts may include any one or more of almonds, brazil nuts, cashews, chestnuts, filberts, hazelnuts, hickory nuts, macadamia nuts, pecans, pine nuts, pistachios, or walnuts. Preferably, the compositions include hazelnuts. In some embodiments, compositions may include peanuts. Peanuts are not a true type of nut botanically, and are actually a legume similar to peas and beans. However, in the culinary world most people include peanuts in a list of common nuts that are good for you. Accordingly, as described herein, nuts may include peanuts.

The composition 103 also includes cocoa. Cocoa is provided by cocoa bean, which is the dried and fully fermented seed of Theobroma cacao, from which cocoa solids (a mixture of nonfat substances) and cocoa butter (the fat) may be extracted. Cocoa beans are the basis of chocolate. Cocoa is both healthy and tasty. Incorporation of cocoa in compositions is thus useful to improve the taste profile.

The composition 103 further includes a natural mold inhibitor. The presence of the natural mold inhibitor helps to provide a long shelf life. For example, the shelf life of compositions described herein is as long as at least 6 months, 8 months, 1 year, or longer, but preferably at least a year. Advantageously, the edible natural mold inhibitor provides a stable shelf life without requiring heat treatment, high quantities of carbohydrates (e.g., sugar), or acidulants. As such, nut spread compositions of this disclosure are chocolate compatible and enjoy all the benefits of a shelf stable product without resorting to the inclusion of unhealthy additives.

Accordingly, nut spread compositions of the present disclosure provide a healthier alternative to nut spreads of the prior art. Preferably, the natural mold inhibitor includes a combination of flaxseed and oregano extracts. As such, the natural mold inhibitor used in compositions of the present disclosure may provide several important benefits, such as, having a minimal to zero impact on flavor, having a clean label, being a non-GMO, being gluten-free and dairy-free, effective at neutral pH, and capable of being provided as a water-soluble liquid or powder to facilitate methods of making the compositions. The natural mold inhibitor may, for example, comprise the natural mold inhibitor sold under the trade name CYTOGUARD by A&B Ingredients. The natural mold inhibitor is preferably provided at a concentration of about 0.5 percent of the total composition.

Compositions of the disclosure are shelf stable through the use of natural ingredients, such as, vegetable glycerin and extracts of Origanum vulgare (essential oil of oregano) and flaxseed. The vegetable glycerin functions as a water activity depressing compound, and the extracts of Origanum vulgare (essential oil of oregano) and flaxseed function as a natural yeast and mold inhibitor.

In preferred embodiments, the composition 101 includes the ingredients at the concentrations recommended in Table 1 below:

TABLE 1

| | Percent | 250 g Batch Size |
|---|---|---|
| Chopped Hazelnuts | 10.3390 | 25.8475 |
| Cocoa powder | 10.1544 | 25.3860 |
| Agave Sweetener Powder | 7.7543 | 19.3858 |
| Whey Protein Powder | 10.7083 | 26.7708 |
| Cocoa Butter | 8.6774 | 21.6935 |
| Vegetable Oil | 2.5116 | 6.2790 |
| Hazelnut Oil | 7.5349 | 18.8373 |
| Hazelnut Extract | 2.4966 | 6.2415 |
| Almond Milk | 17.6821 | 44.2053 |
| Vanilla Extract | 4.8049 | 12.0123 |
| * CytoGuard YM | 0.5000 | 1.2500 |
| Glycerol | 16.8365 | 42.0913 |
| Total | 100.0000 | 250.0000 |

* CytoGuard Ym is a natural yeast and mold inhibitor sold under the trade name CYTOGUARD by A&B Ingredients, Fairfield NJ.

A batch size of 250 grams of the nut spread composition 101, according to the preferred embodiment of Table 1, may be made according to the follow recipe:
1. Grind the hazelnuts in, for example, a food processor (400 watts, Hamilton Beach Div. of Scoville, Inc., Model: 702-3) until fine. Place in stainless steel mixing bowl (bowl A).
2. Add the following weighed dry ingredients to the hazelnuts in bowl A—cocoa powder, whey protein isolate powder. Mix well with, for example, a spatula.
3. To a plastic 250 ml beaker, add the formula amount of cocoa butter (white solid). Cover beaker with plastic wrap and place in a microwave heating oven (e.g., 1800 watts, Whirlpool Corp., Model: WMH 73521CS-6) for about 3 minutes on “high”. The temperature of resultant oil should preferably be about 187 degrees Fahrenheit.
4. To warm (not hot), e.g., 93-101 degrees Fahrenheit, melted cocoa butter in the plastic beaker, add the pre-weighed oil soluble ingredients-vanilla extract, hazelnut extract, hazelnut oil, canola oil and glycerin.
5. Pour the oil-soluble ingredients from the plastic beaker into a stainless-steel mixing bowl (bowl B).
6. Add agave powder to the oil soluble ingredients in bowl B. Mix well with spatula to reduce any lumps from the agave powder.
7. Add contents of bowl B to the Hamilton-Beach food processor. Mix contents for about 10 seconds at high speed.
8. Add contents of bowl A to the food processor. Mix 1 minute at high speed (not homogeneous after mixing; small balls of ingredients present).
9. Add pre-weighed almond milk and CytoGuard YM to food processor and mix on high speed until smooth and homogeneous (about 1 minute).
10. Remove smooth product with a spatula from the food processor and transfer to a glass jar with a metal lid.
12. Refrigerate lidded jar to maintain freshness.

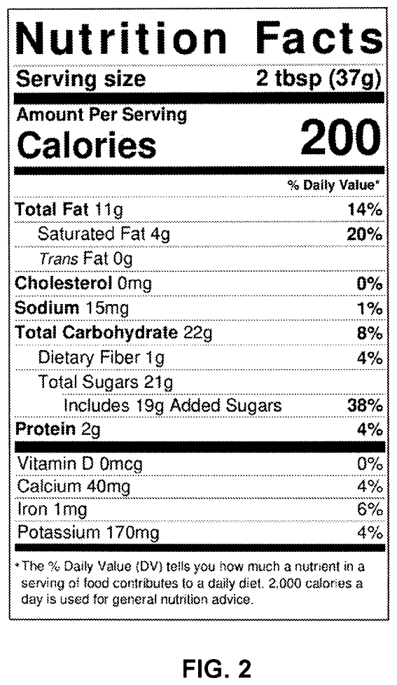

FIG. 2 shows nutritional facts of an exemplary nut spread composition. Advantageously, the nut spread compositions described herein provide a healthier product than leading chocolate hazelnut shelf stable spreads, such as the leading chocolate hazelnut spread sold under the trade name NUTELLA. In particular, nut spreads described herein comprise 20% less calories (160 calories vs. 200 calories) per serving than the leading shelf stable chocolate hazelnut spread. Nut spreads described herein comprise 45% less carbohydrates (12 g versus 23 g) per serving than the leading shelf stable chocolate hazelnut spread. Nut spreads described herein comprise approximately 39% less added sugar (2 g versus 19 g) per serving than the leading shelf stable chocolate hazelnut spread. And, nut spreads described herein comprise 150% more protein (5 g versus 2 g) per serving than the leading shelf stable chocolate hazelnut spread.

Yet another advantage of nut spread compositions described herein, is that the nut spread compositions of this disclosure may be devoid of palm oil. Palm oil is associated with high levels of unhealthy facts, e.g., approximately 50% saturated fat. One insight of the invention is that the, for example, the combination and amounts of ingredients recited in Table 1, compositions can be made without palm oil or artificial flavors, which is commonly found in convention nut spreads.

Palm oil comes from the fruit of the oil palm tree, a type of tree found mainly in warm climates such as Africa and Asia. Palm oil use is controversial because the trees grow in rainforest regions, and the harvesting of this type of oil is being blamed for many negative environmental impacts. As such, compositions described are not only healthier, but also more environmentally friendly than commonly sold nut spreads.

Preferably, the nut spread composition of the disclosure has a neutral pH. For example, preferably the pH is between 6-8, and more preferably the pH is 7. By having a neutral pH, compositions of the disclosure are more compatible with chocolate.

Moreover, nut spread compositions of the disclosure do not require a heat processing step, e.g., pasteurization, cooking, baking, etc., to achieve a stable shelf life. Heat processing involves the application of heat at temperature ranges of between 140 degrees Fahrenheit and 178 degrees Fahrenheit, and time periods ranging from 68 minutes (at 142 degrees Fahrenheit) to 0.5 minutes (at 178 degrees Fahrenheit). Heat processing is one of the most important methods for extending the storage life of foodstuffs. However, heat processing also has a detrimental effect on nutrients since thermal degradation of nutrients can and does occur. Therefore, nut spreads that rely on heat processing have a lower nutrient content than nut spreads described herein, which do not require heat processing. In fact, in preferred embodiments, the only heating step involved is to heat the butter. Moreover, elimination of a heat processing step makes compositions of the disclosure are cheaper, faster, and easier to manufacture, since the time and labor of heat processing is eliminated.

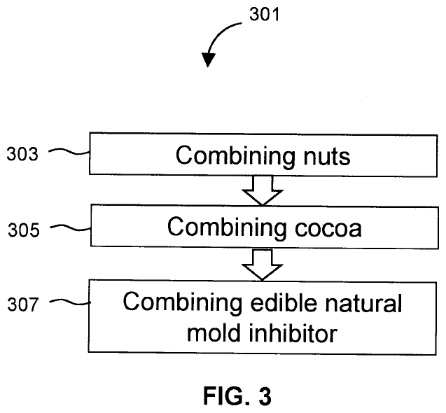

FIG. 3 diagrams a method 301 for making a nut spread composition. The method involves combining nuts 303, cocoa 305, and an edible natural mold inhibitor 307. In preferred embodiments, the method 301 provides nut spread compositions having reduced water activity so as to maintain a long shelf life. However, this method 301—unlike methods of the prior art—achieves reduced water activity using all nature ingredients. For example, in some preferred embodiments, nut spread compositions are made with vegetable glycerin, sometimes referred to as glycerol, for its natural water depressing activities along with extracts of Origanum vulgare (essential oil of oregano) and flaxseed, that function as a natural yeast and mold inhibitor.

Preferably, the natural mold inhibitor comprises a combination of flaxseed and oregano extracts. Benefits of the natural mold inhibitor include a minimal to zero impact on flavor, having a clean label, being a non-GMO, being gluten-free and dairy-free, effective at neutral pH, and capable of being provided as a water-soluble liquid or powder to facilitate methods of making the compositions. Preferably, the natural mold inhibitor comprises approximately 0.5 percent of total composition.

The method 301 may further include adding sweetener derived from agave. Agave is a healthier alternative to sweeteners found in commercially available nut spreads. Most commercially available nut spreads rely on sugar. Sugar consists of sucrose. Sucrose is a disaccharide consisting of one glucose and one fructose molecule. Metabolizing glucose is problematic for many people, especially those with diabetes. Glucose is absorbed directly across the lining of the small intestine into your bloodstream, which delivers it to your cells. As such, it raises blood sugar more quickly than other sugars, which stimulates the release of insulin. Insulin is needed for glucose to enter your cells. Once inside your cells, glucose is either used immediately to create energy or turned into fat. Too much fat leads to obesity.

Agave, on the other hand, consists of fructose, which raises blood sugar levels more gradually than glucose and does not appear to immediately impact insulin levels. Fructose is found naturally occurring in many fruits and most root vegetables.

The sweetener preferably comprises less than 8 percent of the total composition. As such, nut spread compositions have lower levels of sweeter than conventional nut spreads.

The nuts preferably comprise one of peanuts or hazelnuts. Nuts may also include almonds, brazil nuts, cashews, chestnuts, filberts, hazelnuts, hickory nuts, macadamia nuts, pecans, pine nuts, pistachios, or walnuts. The nuts comprise less than 15 percent of total composition.

The method 301 may also include adding whey protein powder. Whey protein powder may comprise more than 10 percent of the total composition. The protein content of nut spreads of this disclosure may make them particularly well suited for consumers with an active lifestyle, e.g., athletes, and in particular those that are interested in building muscle.

Preferably, the method 301 is devoid of palm oil. This is advantageous because, as discussed above, palm oil is associated with high levels of unhealthy facts, e.g., approximately 50% saturated fat. Thus, an insight of the invention is that the method 301, which preferably is achieved following the recipe that is recited above, using the combination and amounts of ingredients recited in Table 1, is made without palm oil or artificial flavors, which are commonly found in convention nut spreads. As such, the method 301 provides nut spread compositions that are healthier and environmentally friendly than commonly sold nut spreads.

The method 301 does not include a cooking step or a heat processing step. Heat processing involves the application of heat ranging between 140 degrees Fahrenheit and 178 degrees Fahrenheit, and time periods between ranging from 68 minutes (at 142 degrees Fahrenheit) to 0.5 minutes (at 178 degrees Fahrenheit). Heat processing is one of the most important methods for extending the storage life of foodstuffs. However, heat processing also has a detrimental effect on nutrients since thermal degradation of nutrients can and does occur. Therefore, nut spreads that rely on heat processing have a lower nutrient content than nut spreads described herein, which do not require heat processing. In fact, in preferred embodiments, the only heating involved is to heat the butter (preferably with a microwave). Because the method 301 eliminates cooking compositions of the disclosure are cheaper, faster, and easier to manufacture, since the time and labor of heat processing is eliminated.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A low-water activity nut spread composition comprising:
nuts;
cocoa; and
an edible natural mold inhibitor.

2. The nut spread composition of claim 1, wherein the natural mold inhibitor comprises a combination of flaxseed and oregano extracts.

3. The nut spread composition of claim 1, wherein the composition comprises a neutral pH.

4. The nut spread composition of claim 1, wherein the nuts comprise hazelnuts.

5. The nut spread composition of claim 1, wherein the composition is shelf stable.

6. The nut spread composition of claim 1, further comprising a sweetener derived from agave.

7. The nut spread composition of claim 6, wherein the sweetener comprises organic agave inulin powder.

8. The nut spread composition of claim 1, further comprising an oil comprising at least one of vegetable oil and hazelnut oil.

9. The nut spread composition of claim 1, further comprising a plant milk.

10. The nut spread composition of claim 1, further comprising an agent that reduces water activity.

11. A method for preparing a nut spread composition, the method comprising combining nuts, cocoa, and an edible natural mold inhibitor.

12. The method of claim 11, wherein the natural mold inhibitor comprises a combination of flaxseed and oregano extracts.

13. The method of claim 12, wherein the natural mold inhibitor comprises approximately 0.5 percent of total composition.

14. The method of claim 11, further comprising adding a sweetener derived from agave.

15. The method of claim 14, wherein the sweetener comprises less than 8 percent of the total composition.

16. The method of claim 11, wherein the nuts comprise at least one of peanuts and hazelnuts.

17. The method of claim 16, wherein the nuts comprise less than 15 percent of total composition.

18. The method of claim 11, further comprising adding whey protein powder, wherein the whey protein powder comprises more than 10 percent of the total composition.

19. The method of claim 11, further comprising adding a low water activity agent.

20. The method of claim 11, wherein the method is devoid of a cooking step.
